(19) United States
(12) Patent Application Publication
(10) Pub. No.: US 2014/0102613 A1
(43) Pub. Date: Apr. 17, 2014

(54) LAMINATION METHOD OR THE IMAGE SHEET-LIKE MATERIAL USING A LAMINATING POUCHES, AND A METHOD FOR PREPARING POUCHES

(71) Applicant: Maping Co., Espoo (FI)

(72) Inventor: Henri Huotari, Espoo (FI)

(21) Appl. No.: 14/027,558

(22) Filed: Sep. 16, 2013

(30) Foreign Application Priority Data
Sep. 17, 2012 (DE) 102012108728.8
Sep. 28, 2012 (DE) 102012217834.1

(51) Int. Cl. B32B 37/14

(52) U.S. Cl. CPC B32B 37/142
USPC 156/60; 428/35.2

(57) ABSTRACT

A lamination pouch comprises a thin lamination film provided with a heat-activated adhesive, and its backing material. The lamination film is fastened to the backing material in the longitudinal direction from the opposite segments so that the lamination film is pre-tensioned by means of the backing material, whereby the lamination film and the backing material make up a longitudinal lamination pouch. An image is inserted into the lamination pouch. The lamination pouch selected so that the image is shorter than the longitudinal lamination pouch, in such a way that the image comes against one fastened segment. The lamination pouch containing the image is fed into a lamination device with the image-side fastened segment first. In this case, the lamination of the image by using a thin lamination film can be done successfully also by means of a simple and readily available pouch laminator.

### CROSS-REFERENCE TO RELATED APPLICATIONS

This application claims priority from German Patent Application Number 10 2012 217 834.1 titled “LAMINATION POUCH, METHOD FOR THE LAMINATION OF IMAGE OR SHEET MATERIAL BY USING THE LAMINATION POUCH, AND METHOD FOR THE MAKING OF THE LAMINATION POUCH” filed on Sep. 28, 2012 and German Patent Application Number 10 2012 108 728.8 titled “LAMINATION POUCH, METHOD FOR THE LAMINATION OF IMAGE OR SHEET MATERIAL BY USING THE LAMINATION POUCH, AND METHOD FOR THE MAKING OF THE LAMINATION POUCH” filed on Sep. 17, 2012 and are both incorporated fully herein by reference.

### FIELD OF INVENTION

The invention relates to the lamination of images and sheet materials.

### TECHNICAL BACKGROUND

In the graphics industry, the objective in the further processing of printing and in other uses is sometimes to protect not only a photograph or an image printed with a printer or printing press (in what follows, all of these referred to jointly as: image) or to enhance the aesthetic impression given by the image. This can be done by means of a sufficiently thin lamination on the face of the image.

An image (or other sheet) can be laminated on both sides using prior art lamination pouches. According to Wikipedia (http://en.wikipedia.org/wiki/Pouch_laminator), the thickness of lamination pouches used currently is approximately 80-250 μm.

Known lamination pouches are disclosed from patent publications such as U.S. Pat. No. 7,267,857 B1 and U.S. Pat. No. 3,614,839 as well as patent application publications WO 99/07802 A1 and US 2001/0039998 A1. By using these lamination pouches, an image or other sheet can be laminated by means of an ordinary pouch laminator (in German Taschenlaminator). An image is inserted into the pouch formed by the laminate and substrate, used in the pouch laminator. The substrate contains heat-activated adhesive. The pouch is carried through hot pressing rollers, whereby the layers in the pouch are bonded to each other.

However, the solutions described in the publications referred to in the preceding paragraph do not help in a situation where it is necessary to laminate an image on one side only, or in general using a very thin laminate. This is especially the case when the purpose is to enhance the aesthetic impression given by the image. This is so because upgrading the aesthetic impression of the image requires a sufficiently thin single-sided lamination.

By the term “thin” is meant a material thickness of about 30-76 μm.

Lamination as thin as this is currently only possible by means of a roll laminator (in German Rollenlaminator), where the lamination film is on a roll of its own, and the counter roll contains a back material, such as paper, and where the images to be laminated are fed into the roll laminator between the lamination film and paper.

A roll laminator is much more expensive to purchase than a pouch laminator. In addition, the roll laminators known in the prior art usually create at least a few wasted items when applying a thin lamination before the lamination begins to work properly.

### OBJECTIVE OF INVENTION

The objective of the present invention is to enable thin lamination by means of a pouch laminator and/or to reduce the number of waste items when making thin lamination.

This objective can be attained by means of the lamination pouch in accordance with independent claim 1 and by means of the lamination method for an image or sheet material in accordance with independent claim 7, by using a lamination pouch. The lamination pouch in accordance with the claim 1 can be made using the lamination pouch fabrication method in accordance with the claim 10.

The dependent claims describe the preferred aspects of the various embodiments of the invention.

### ADVANTAGES OF INVENTION

The lamination pouch comprises a thin lamination film provided with a heat-activated adhesive, and its back material. The lamination film is fastened to the back material in the longitudinal direction from the opposite segments so that the lamination film is pre-tensioned by means of the back material, whereby the lamination film and the back material make up a longitudinal lamination pouch.

By using pre-tensioning, the thin lamination film does not become wrinkled as easily as without pre-tensioning. Owing to the lamination pouch I have invented, the thin lamination of images is possible even with a simple pouch laminator.

When the lamination film is fastened to the back material by using the heat-activated adhesive in the lamination film, the number of components needed to make the lamination pouch can be kept to a minimum.

When the length between the segments in the back material is greater than or equal to the length between the segments in the lamination film, in which case the back material pre-tensions the lamination film as the back material attempts to straighten, the lamination pouch can be made in a relatively simple manner by adjusting the mutual feed length of the back material and the lamination film, or by adjusting the feeding speed.

The invention is most advantageous when the thickness of the lamination film is less than 80 μm and most preferably 30-76 μm. In this way, the lamination pouch allows the thin lamination of images and other types of sheet material using prior art pouch laminators. We have successfully tested lamination films with a thickness of 32 μm and 40 μm.

The above-mentioned thickness is very well suited for the lamination of printed book cover images so that the cover image can be made to fold neatly over the edge of the cover stiffener. The above-mentioned thickness enables the easy shaping of treated paperback book covers and adhesive-bound magazine covers: the folding lines in particular can be made easily, and the covers can be bent with ease.

When the back material is selected in such a way that its modulus of elasticity is greater than the modulus of elasticity of the lamination film so that when the back material, which is shorter than or as long as the lamination film over its length between the opposite segments, attempts to straighten, it simultaneously pre-tensions the lamination film over the portion between the segments, the pre-tensioning required to keep the lamination film tensioned can be accomplished at a desired ratio of the lengths or moduli of elasticity.

The invention is most advantageous when the adhesive bonding in one segment is weaker than in the other segment. In this case, the end with the weaker adhesive bonding in the lamination pouch can be opened more easily during working. In manual work, this reduces the burden experienced by the employee and the strain of the work.

In the method for the lamination of an image or sheet material by using the lamination pouch, the image is inserted into the lamination pouch in accordance with the first aspect of the invention, with the lamination pouch selected so that the image is shorter than the longitudinal lamination pouch, in such a way that the image comes against one fastened segment. The image is fed into the lamination device with the image-side fastened segment first. In this case, the lamination of the image by using a thin lamination film can be done successfully also by means of a simple pouch laminator due to pre-tensioning. Potential wrinkles in the lamination film are most likely to occur only on the side of the other fastened segment of the lamination pouch, in other words at that edge to where the image or sheet material no longer reaches.

When the lamination film is released from the back material partly or entirely at the opposite fastened segment after the feeding of the lamination pouch into the lamination device has started, the likelihood of wrinkles in the lamination film on the face side of the image or sheet material can be reduced.

In the method for the fabrication of the lamination pouch, a thin lamination film, which is provided with a heat-activated adhesive, and the back material are run through the heated rollers of the roll laminator in order to create the first segment, in which segment the lamination film is fastened to the back paper. After this, the running is continued with the rollers released from each other and/or with the rollers cooled. Then the thin lamination film, which is provided with a heat-activated adhesive, and the back material are run through the heated rollers of the roll laminator in order to create the second segment, in which segment the lamination film is fastened to the back paper. All this is done in such a manner that the lamination film becomes fastened to the back paper in the longitudinal direction from the opposite segments in order to pre-tension the lamination film by means of the back paper, whereby the lamination film and the back paper make up a longitudinal lamination pouch in accordance with a first aspect of the invention.

The method enables the fabrication of lamination pouches using simple means which, however, currently have a higher procurement cost, in other words using a roll laminator. The lamination of images and sheet material; in turn, by means of lamination pouches made in this manner is possible using even simpler means with very inexpensive procurement costs, in other words using a pouch laminator.

In accordance with a preferred embodiment of the method, the adhesive bonding in the first segment is made weaker than the adhesive bonding in the second segment. In this way, the end of the lamination pouch going into the lamination device later can be opened more easily without disturbing the lamination event. This is of great importance for example when the opening takes place when a table laminator has already started the lamination of the lamination pouch. Otherwise, if considerable force was needed to open the pouch, it would be possible that the end result will have wrinkles or the lamination film is damaged due to the force used for opening.

The weaker adhesive bonding in the first segment is most easily implemented by running the lamination pouch at the segment in question in a roll laminator at a higher running speed and/or at a lower temperature than at the second segment. By a lower temperature in this context, we mean a temperature which is lower than the working temperature of the heat-activated adhesive (hot melt adhesive) (e.g. 170° C.) in the lamination pouch, but still higher than the melting temperature of the adhesive (e.g. 90° C.)

The adhesive bonding of the second segment (in other words that segment against which the image is evened out) should be made stronger than the adhesive bonding of the first segment, because this enables a better prevention of the unintended opening of the lamination pouch especially when the image to be inserted into the lamination pouch is pushed against the segment in the lamination pouch.

### LIST OF DRAWINGS

In what follows, the lamination pouch, the method for the lamination of an image or sheet material by using the lamination pouch, and the method for the making of the lamination pouch are presented in more detail by means of the exemplary embodiments in the enclosed drawings. The drawings show:

FIG. 1 is a plan view of the lamination pouch according to the invention;

FIG. 2 illustrates a lamination pouch according to the invention and an image to be inserted into the lamination pouch;

FIG. 3 illustrates an image inserted into the lamination pouch;

FIG. 4 illustrates the image of FIG. 3 taken beside the segment fastened in the lamination pouch; and

FIG. 5 shows an image laminated in the lamination pouch in accordance with the invention.

The same reference numbers refer to the same parts in all FIGS.

### DETAILED SPECIFICATION

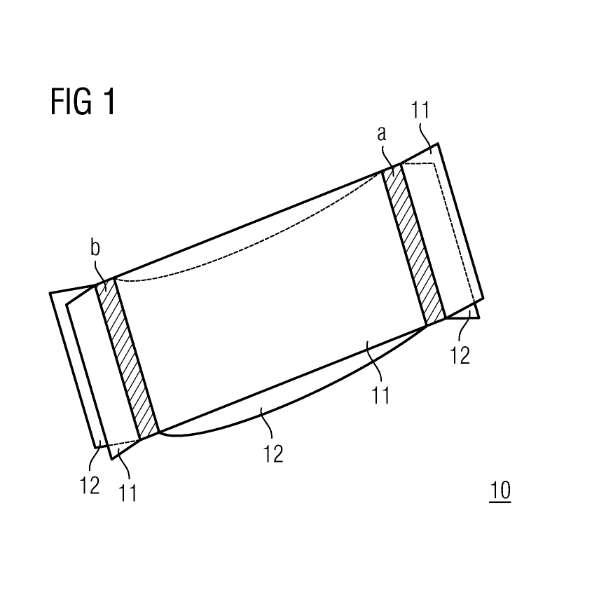

FIG. 1 shows the lamination pouch 10. The lamination pouch 10 comprises a thin lamination film 11 provided with a heat-activated adhesive, and its back material 12. The lamination film 11 is most preferably made of polyester or nylon. The back material 12 is most preferably of 190 g/m² cardboard, but other grades can also be used.

The lamination film 11 is fastened to the back material 12 in the longitudinal direction from the opposite segments a, b for the pre-tensioning of the lamination film 11 by means of the back material 12, whereby the lamination film 11 and the back material 12 form a longitudinal lamination pouch 10.

The fastening of the lamination film 11 to the back material 12 is carried out at the segments a and b most preferably by using the heat-activated adhesive in the lamination film 11. The heat-activated adhesive is most preferably hot melt adhesive (in German Schmelzklebstoff). Other types of fastening, for example by using pressure-activated adhesive, are also possible.

Most preferably, the length between the segments a, b in the back material 12 is greater than or equal to the length between the segments a, b in the lamination film 11. In this case, the back material 12, while it attempts to straighten, pre-tensions the lamination film 11.

In order to enable a thin lamination, the thickness of the lamination film 11 in the lamination pouch 10 is preferably less than 80 μm and most preferably between 30-76 μm.

The back material 12 can be selected so that its modulus of elasticity is greater than the modulus of elasticity of the lamination film 11. In so doing, a particularly good end result is achieved in such a way that while the back material 12, which is shorter than or as long as the lamination film 11 over its length between the opposite segments a, b, attempts to straighten, it also pre-tensions the lamination film 11 over the section between the segments a, b.

In the method for the making of the lamination pouch 10, a thin lamination film 11, which is provided with a heat-activated adhesive, and the back material 12 are run through the heated rollers of the roll laminator in order to create the first segment a, in which segment the lamination film 11 is fastened to the back paper 12. After this, the running is continued with the rollers released from each other and/or with the rollers cooled. Then the thin lamination film 11, which is provided with a heat-activated adhesive, and the back material 12 are run through the heated rollers of the roll laminator in order to create the second segment b, in which segment the lamination film 11 is fastened to the back paper 12.

This results in the lamination pouch 10, where the lamination film 11 is fastened to the back paper 12 in the longitudinal direction from the opposite segments a, b for the pre-tensioning of the lamination film 11 by means of the back paper 12, whereby the lamination film 11 and the back paper 12 form the above-presented longitudinal lamination pouch 10.

The lamination pouch 10 can be cut at the segments a, b or outside an area between them so that there are no ends which hang to different directions from each other, as shown in FIG. 1 (FIG. 1: on the left side of segment b and on the right side of segment a). Alternatively, the back material 12 can be left to be longer than the lamination film 11 at one end or both ends of the lamination pouch 10.

If the back material 12 at the latter end (a) of the lamination pouch 10 going into the lamination device is longer than the lamination film 11, it is easier to prevent the soiling of the rollers of the lamination device.

If the lamination film 11 has been cut off at the first end (b) of the lamination pouch 10 going into the lamination device so that there is no loose end, the potential wrapping of the lamination film 11 on the rollers of the lamination device can be prevented better.

The width of the segments a, b is actually irrelevant. However, we found that a width of about 15-20 mm works well.

We have found that one well-functioning dimensioning is 32 μm polyester film and 790 mm×260 mm for an image 20 of 680 mm×260 mm, where 790 mm is the free distance between the segments a and b. In this embodiment, it was not necessary to release the latter segment of the lamination pouch 10 going into the lamination device.

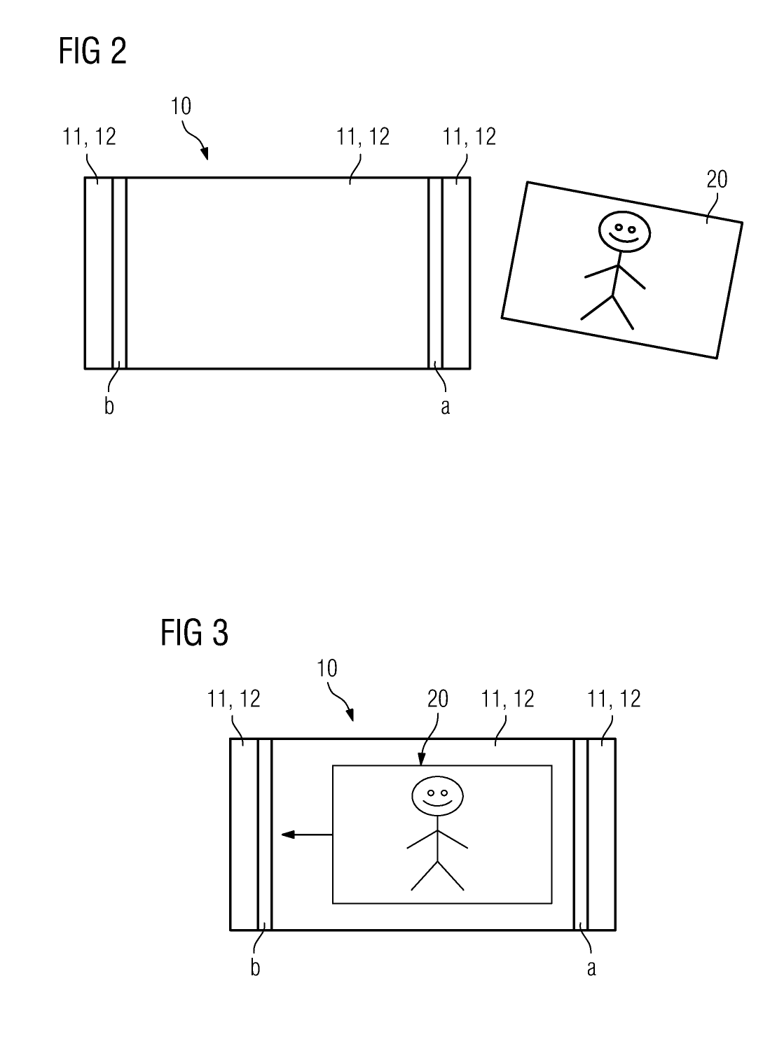

FIGS. 2-5 show the method for the lamination of an image 20 or sheet material by using the lamination pouch 10 of the invention. Sheet material here refers specifically to a material made, most preferably printed, on paper, paperboard, cardboard or metal foil. The image 20 can be made for example by means of an inkjet printer, laser printer or solid wax printer, although in principle any other prior art exposure, printing and printing press methods can be used.

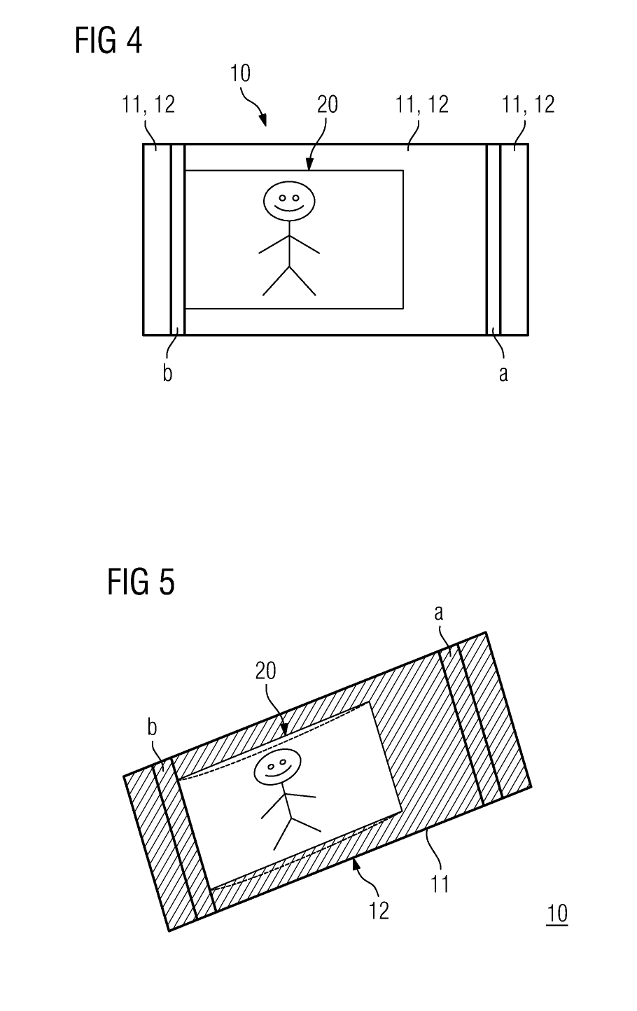

The image 20 is inserted (cf. FIG. 2) into the lamination pouch 10, which is selected so that the image 20 is shorter than the longitudinal lamination pouch. The image 20 is inserted (cf. FIG. 3) into the lamination pouch 10 so that the image 20 comes against one fastened segment b, whereby the end result is that shown in FIG. 4. The insertion of the image as shown in FIGS. 2 and 3 can be done in the same step of the method, in which case the image is inserted into the lamination pouch 10 directly to the point indicated in FIG. 4.

After this, the image 20 in the lamination pouch 10 is fed into the lamination device (not shown but well known in the art) with the image-side fastened segment b first.

The lamination film 11 can be released partly or completely from the back material 12 at the fastened segment “a” opposite to the feed segment after the feeding of the lamination pouch 10 into the lamination device has started.

The invention should not be understood to be limited only by the below claims, but the invention is to be understood to include all their legal equivalents and the combinations of the embodiments presented.

Modifications and substitutions by one of ordinary skill in the art are considered to be within the scope of the present invention, which is not to be limited except by the allowed claims and their legal equivalents.

1. A lamination pouch (10), comprising:
a thin lamination film (11) provided with a heat-activated adhesive; and
a backing material (12); and wherein the lamination film (11) is fastened to the backing material (12) in a longitudinal direction from the opposite segments (a, b) for pre-tensioning the lamination film (11) by means of the backing material (12), whereby the lamination film (11) fastened to the backing material (12) form a longitudinal lamination pouch (10).

2. The lamination pouch (10) according to claim 1, where the said fastening of the lamination film (11) to the back material (12) is carried out by using a heat-activated adhesive in the lamination film (11).

3. The lamination pouch (10) according to claim 1, wherein the length between the segments (a, b) of the backing material (12) is greater than or equal to the length between the segments (a, b) of the lamination film (11), whereby the backing material (12), as it attempts to straighten, pre-tensions the lamination film (11).

4. The lamination pouch (10) according to claim 1, wherein the thickness of the lamination film (11) is less than 80 μm and most preferably between 30-76 μm.

5. The lamination pouch (10) according to claim 1, wherein the backing material (12) is selected in such a way that its modulus of elasticity is greater than a modulus of elasticity of the lamination film (11) so that when the backing material (12), which is shorter than or as long as the lamination film (11) over its length between the opposite segments (a, b), attempts to straighten, it simultaneously pre-tensions the lamination film (11) over the portion between the segments (a, b).

6. The lamination pouch (10) according to claim 1, where an adhesive bonding in one segment (a) is weaker than an adhesive bonding in the other segment (b).

7. A method for the lamination of an image (20) or sheet material by using the lamination pouch (10) of claim 1, characterized in that:
an image (20) is inserted into a lamination pouch (10), wherein the lamination pouch (10) is selected so that the image (20) is shorter than the longitudinal lamination pouch (10) in such a manner that the image (20) comes against one fastened segment (b); and wherein
the image (20) is fed into the lamination device with the image-side fastened segment (b) first.

8. The method according to claim 7, wherein the lamination film (11) is released partly or completely from the back material (12) at the opposite fastened segment (a) after the feeding of the lamination pouch (10) into the lamination device has started.

9. The method according to claim 7, where said method is used for the lamination of a cover image for a hardback book cover or for the lamination of a paperback book cover or adhesive-bound magazine cover.

10. A method for the fabrication of a lamination pouch (10) according to claim 1, characterized in that:
said thin lamination film (11), which is provided with a heat-activated adhesive, and said backing material (12) are run through the heated rollers of a roll laminator in order to create the first segment (a), in which segment the lamination film (11) is fastened to the backing paper (12);
the running is continued with the rollers released from each other and/or with the rollers cooled;
the thin lamination film (11), which is provided with a heat-activated adhesive, and the backing material (12) are run through the heated rollers of a roll laminator in order to create the second segment (b), in which segment the lamination film (11) is fastened to the backing paper (12);
such that the lamination film (11) is fastened to the backing paper (12) in the longitudinal direction from the opposite segments (a, b) for pre-tensioning the lamination film (11) by means of the back paper (12), whereby the lamination film (11) fastened to the back paper (12) form said longitudinal lamination pouch (10).

11. The method according to claim 10, where the adhesive bonding in the first segment (a) is weaker than the adhesive bonding in the second segment (b).

12. The method according to claim 11, wherein the weaker adhesive bonding in the first segment (a) is implemented by running the lamination pouch (10) at the segment (a) in question in a roll laminator at a higher running speed and/or at a lower temperature than the running speed and/or temperature of the second segment (b).

13. The method according to claim 12, wherein the lower temperature is above the melting temperature of the heat-activated adhesive contained in the lamination film (11) but below the normal working temperature of the adhesive in question.
